(19) United States
(12) Patent Application Publication
(10) Pub. No.: US 2002/0038221 A1
(43) Pub. Date: Mar. 28, 2002

(54) Competitive reward commerce model

(76) Inventors: Vivek John Tiwary, New York, NY (US); Gary Lee Kaplan, New York, NY (US)

Correspondence Address: Gary Kaplan, 1 Iruing Place, P7H, New York, NY, 10003, US

(21) Appl. No.: 09/945,017

(22) Filed: Aug. 31, 2001

Related U.S. Application Data
(60) Provisional application No. 60/229,283, filed on Aug. 31, 2000.

(51) Int. Cl. G06F 17/60

(52) U.S. Cl. 705/1

(57) ABSTRACT

An online competitive commerce program (the “Program”) rewards artists and record labels that have manufactured compact disks or other products based on the number of such products sold online through the Web site of an Internet sales entity. The Program, created for use with music industry merchants, awards a cash prize on a monthly basis to the artist or label whose product sells in the greatest quantity. Such products include CDs, T-shirts, concert tickets, etc.

### RELATED APPLICATION

Application claims priority to provisional application 60/229,283 filed on Aug. 31, 2001.

### APPENDIX

Attached hereto are appendix A, B, and C, which illustrate the invention in operation.

Appendix A is a summary of the invention as applied to a reward model based on CD sales and Mailing List additions.

Appendix B is a deleted summary explaining the rules and procedures relating to a CD salesbased embodiment of this invention.

Appendix C is a deleted summary explaining the rules and procedures relating to a Mailing Listbased embodiment of this invention.

### BACKGROUND OF THE INVENTION

The present invention relates to a reward program used by a merchant that sells products via the World Wide Web to provide incentives to suppliers to use the merchant as their retailer and to promote the Web site of the merchant.

Traditional incentive models typically reward the purchaser by offering rebates, product credit, or other merchandise, or reward the retailer by giving cash and/or bulk rate discounts based on the quantity of products ordered or sold. Similarly, suppliers or retailers may offer commissions or prizes to a retailer's sales force. With respect to purchaser incentives, these programs are designed to encourage customer loyalty and/or present the appearance that the customer has received a bargain. With respect to retailers or their sales force, these programs are designed to motivate sales people to aggressively promote the supplier's products or services.

No reward models, however, effectively provide suppliers incentives to (1) direct potential customers to a particular retailer; (2) produce a better product; and (3) market the product themselves, by offering a prize to the supplier whose product sells in the greatest quantity over the retailer's Web site. Companies that operate in-part over the World Wide Web fiercely compete for new users in order to drive-up both their advertising revenue, which is proportional to user traffic, and their sales revenue. The Program described herein is a novel method of getting suppliers to help a merchant to obtain these end-results.

### SUMMARY OF THE INVENTION

The invention described herein includes a method of selling items that awards a cash prize on a monthly basis to the supplier whose product sells in the greatest quantity. By way of example only, such suppliers include bands, record labels, manufacturers, or distributors.

In view of the background provided above, the present invention is advantageous in that it provides incentives to suppliers to (1) use the merchant's Web site to distribute their products and services; (2) promote the merchant's Web Site in so much as they are trying to win the reward that is offered by the Company; and (3) provide hyperlinks to the merchant's Web site on the suppliers'Web sites. As a result, the merchant will receive: revenue in the form of a percentage of sales; increased advertising revenue resulting from an increased in site traffic; and increased brand awareness stemming from exposure gained from the program and the traffic it generates.

The Program provides several benefits to suppliers that assures their participation. These include: increased sales of products and services; promotion on the merchant's Web Site; and, most importantly, the potential for a large reward if the supplier should “win” the competition.

As will be apparent, one of ordinary skill in the art will readily appreciate other applications in all areas of commerce, both online and offline, entertainment and otherwise. By way of example only, this model can be used by online merchants such as Amazon.com to sell books, or at an offline retailer such as Barnes & Noble. Either could offer an award based on the sales of books by competing authors or publishers. As will also be apparent to one skilled in the art, this model could be applied by a company that is not a merchant in the traditional sense, but instead serves as an information portal, such as About.com (e.g., by awarding prizes to their most popular content providers).

### BRIEF DESCRIPTION OF THE DRAWINGS

FIG. 1 is a schematic view of the system in accordance with the invention.

FIG. 2 is a schematic view of the system of FIG. 1 operating with a tiered structure.

FIG. 3 is a schematic view of the system of FIG. 1 demonstrating a non-sales driven competition.

FIG. 4 is a schematic view of the system of FIG. 1 utilizing a referral sales method where a prize is offered by a middle-man.

FIG. 5 is a schematic view of the system of FIG. 1 utilizing a referral sales method where a prize is offered by the merchant.

### DETAILED DESCRIPTION OF THE PREFERRED EMBODIMENT

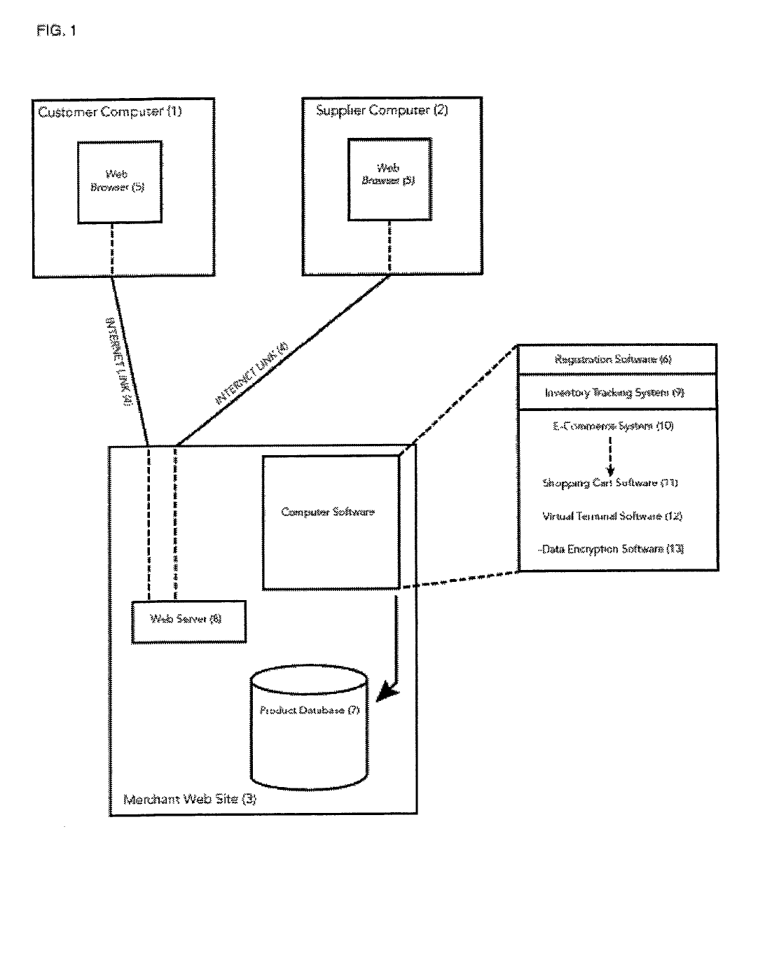

A preferred embodiment of the invention will now be described in detail with respect to its various applications in internet-based music retail with reference to FIGS. 1-5. The system described is intended for use by web-based retailers that sell the products of developing musicians and small record labels. As previously mentioned, however, numerous applications exist.

FIG. 1 illustrates the general architecture of a sales/reward system that operates in accordance with the present invention. The system includes a customer computer 1, a supplier computer 2 and a merchant Web site 3, which are linked together by the Internet 4. The customer computer 1 and supplier computer 2 may be any type of computing devices that allow a user to interactively browse Web sites via a Web browser 5. For example, the customer computer 1 may be a personal computer that runs the Windows 2000 operating system.

The merchant Web site 3 is a site that allows customers to purchase products. Typically, site 3 will be operated by a merchant that handles the various order processing, shipping, collections, and customer service tasks associated with the sale of goods. One such merchant is StarPolish LLC.

The site 3 includes registration software 6 that allows a supplier operating supplier computer 2 to register as a supplier of site 3. The supplier must complete an online registration process, providing various information relating to both the supplier and the product(s) it wishes to sell on Site 3. This information is then stored in product database 7.

Merchant site 3 also includes a Web server 8, which allows merchant site 3 to communicate with other servers or computers via the World Wide Web. Merchant site 3 further includes an inventory tracking system 9. Inventory tracking system 9 allows the merchant to keep track of the quantity of product received from the supplier, sold to the customers, and remaining for sale to future customers. Merchant site 3 additionally includes an e-commerce system 10, which allows consumers to purchase products via merchant site 2 and handles the commerce element of such transactions. E-commerce system 10 includes electronic shopping cart software 11, virtual terminal software 12, and data encryption software 13. Third-parties not shown may be required to provide services relating to credit card authorization and merchant banking.

In operation, the program works as follows: A supplier operating supplier computer 2 visits merchant Web site 3 by using Web browser 5. The supplier, desiring to sell product through Merchant Web site 3, completes a registration process, which is powered by registration software 6. The information concerning the product and the supplier is stored in product database 7. Supplier then ships its product to merchant, who, in turn, enters the quantity of product into inventory tracking system 9 and stores product into warehouse 14. Alternatively, the supplier might be directed to ship its product to a third-party fulfillment company that handles the warehousing and shipping of product for the merchant.

In one embodiment, the customer computer 1 used to browse through merchant Web site 3 or purchasing a product may be a wireless device, known to those skilled in the art.

A customer, desiring to browse the selection of products in product database 7 or to purchase a particular product, visits merchant Web site 3 using Web browser 5 to communicate with merchant site 3. The customer then adds the product(s) to his shopping cart and makes a purchase via e-commerce system 10. Following the sale is entered into inventory tracking system 9.

At the close of each month or other time period, the total sales for each product are tallied via inventory tracking system 9. The merchant then awards a cash prize to the supplier who has sold the most number of any individual product.

In one embodiment, the products sold include compact discs (“CDs”), DVDs, video tapes, t-shirts, MP3s, concert tickets, stickers, or may include products that are not at all related to entertainment. The suppliers of such products could be bands, musicians or record labels. In the event that more than one type of product is sold at any given time, it may be desirous for merchant to offer a cash prize for each type of product.

In addition to or in lieu of these competitions, the merchant may give awards based on criteria other than units sold. By way of example only, the award(s) could be given to the suppliers whose products (a) generate the greatest revenue or profit for the company, (b) show the greatest increase in number of sales, or (c) show the greatest increase in sales revenue. Furthermore, as should be apparent to those skilled in the art, the award described herein need not be cash-based.

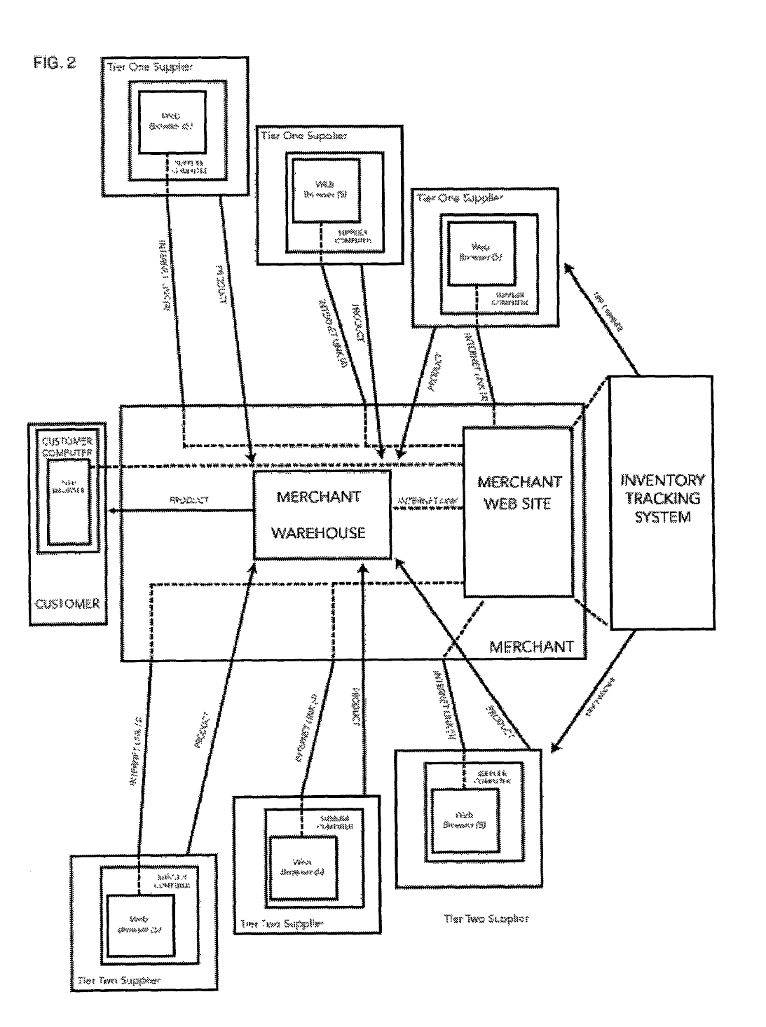

In another embodiment of the invention, shown in FIG. 2, the program operates on two or more tiers and awards two or more cash prizes. These tiers may be defined by any combination of eligibility restrictions, prize value or other criteria. By way of example only, a two tiered system might be structured thusly: Tier 1 is open to all suppliers that want to compete for the monthly Tier 1 prize, $10,000. In order to participate in the Tier 2 competition, however, an entrant must not have sold more than 200 units in any given month. The winner of the monthly Tier 2 competition receives $1000. Alternatively, these criteria can serve as guidelines rather than restrictions, whereby a supplier that averages less than 200 units in a given month is encouraged to participate in Tier 2 and those that sell greater quantities are encouraged to participate in Tier 1. Rather than or in addition to limiting entrants to the Tier 2 competition as described above, the Company may also limit Tier 2 entrants to those suppliers that have not won a Tier 2 competition.

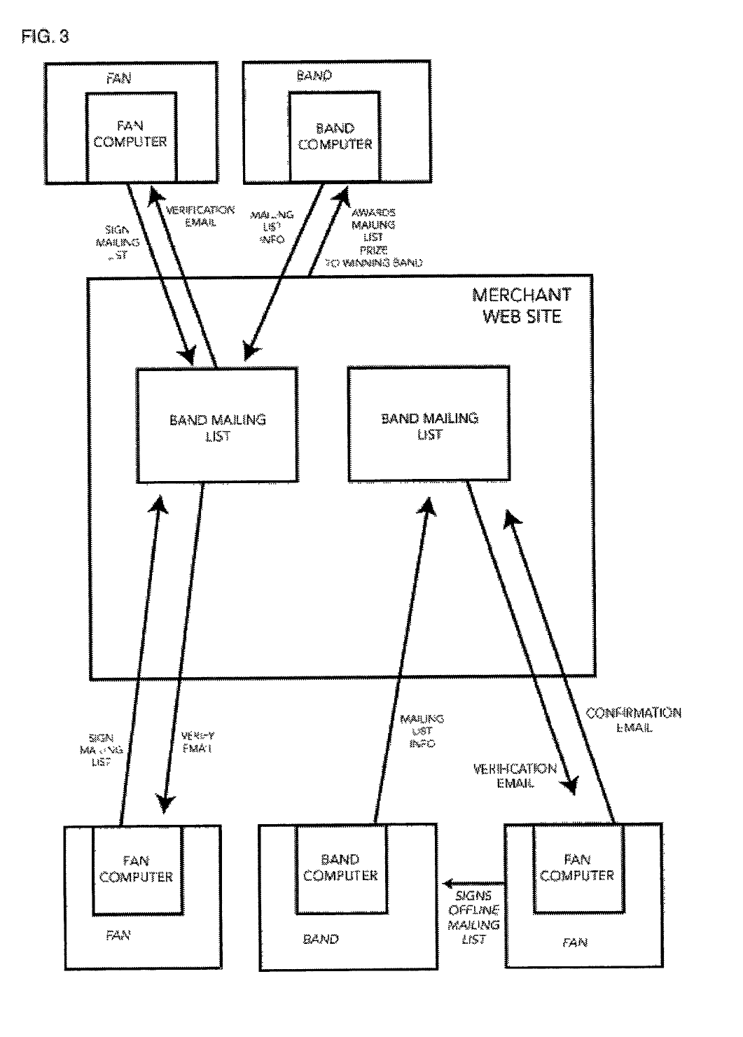

FIG. 3 shows another embodiment of the invention. In this embodiment, suppliers compete for prizes based on non-sales driven criteria. For example, FIG. 3 illustrates a competition where bands augment their mailing lists by either entering their fan's information or encouraging their fans to join their mailing list through the Company Web Site. The company may choose to verify the entries by sending an email to the fans listed, and requiring that they reply to be counted for purposes of the competition or may choose to employ a different verification process. At the end of each month or other time period, the band that has registered the greatest amount of new fans during such time period or that has the most total number of registered fans on its mailing list wins a cash prize.

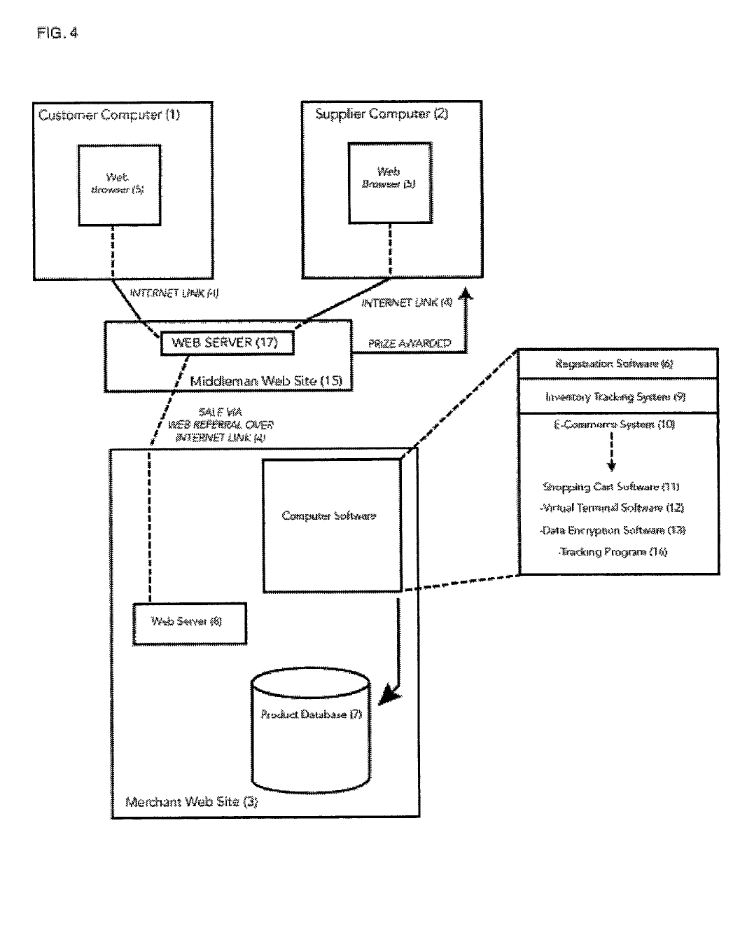

FIG. 4 illustrates yet another embodiment where, rather than directly selling a product or service, a middle-man having a middle-man web site 15 with web server 17 refers the end-user to merchant site 3 that finalizes the sale of a product or service. At the end of each month, a tracking program 16 known to those skilled in the art will tally the number of products sold and revenue generated from such sales as a result of the middle-man's references. The supplier whose product sold in the greatest quantity, accounted for the most revenue, or showed the greatest increase in revenue or products sold as a result of such reference wins a prize from the middle-man.

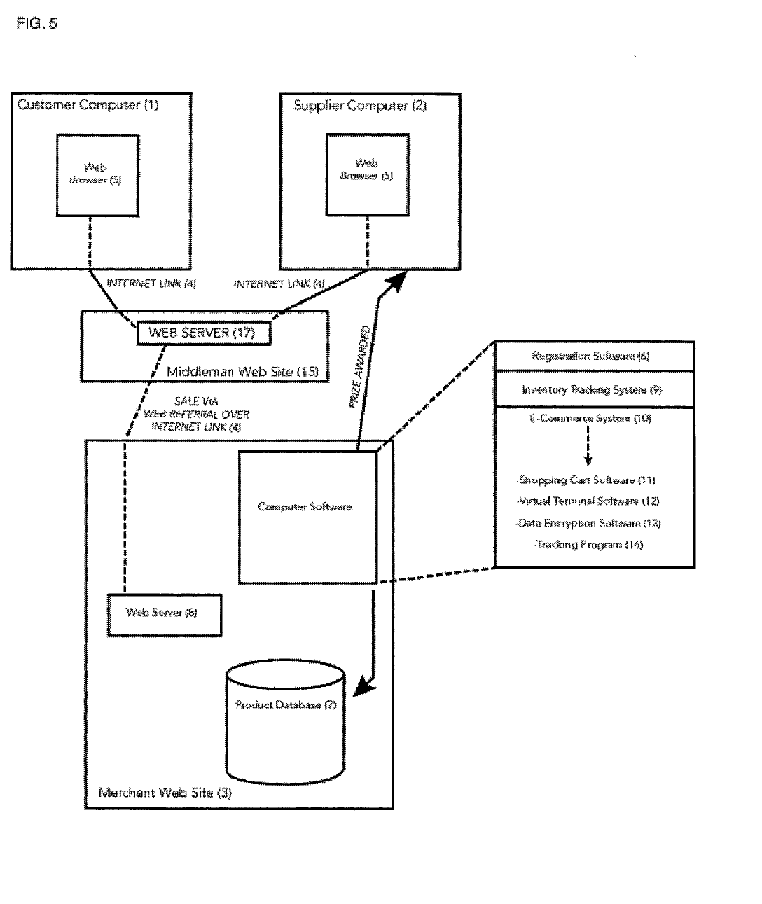

FIG. 5 illustrates yet another embodiment that also uses a middle-man to refer the end-user to another site or merchant that finalizes the sale of a product or service. At the end of each month, a inventory tracking system 9 will tally the number of products sold and revenue generated from such sales as a result of the middle-man's references. The middle-man whose references have

Appendix A

Artist Rewards

“Hard Work Pays Off” and we at StarPolish put our money where our mouths are. If you take our advice and work hard to develop your career, we will reward you with good old-fashioned cash-from $2,500 to $25,000. Additionally, all winners will have their songs featured on a CD that will go to our 25-member A&R Panel <LINK TO SEGMENT> of music industry executives from the major and independent record labels, all actively seeking new artists to sign. No strings attached. So check out the opportunities below, and always remember: the harder you work, the better your luck gets.

Developmental Grants <LINK>

StarPolish has a non-profit arm, The StarPolish Foundation, whose mission is to support the musical arts by raising money and distributing that money to deserving artists in the form of developmental grants. We offer two $25,000 grants: the SuperNova Grant given to a single artist or group, and the StarCluster Grant given to a collective of artists or an emerging music scene. Read more <LINK> to find out how to apply for a grant or make a donation to our Foundation.

Record Sales <LINK>

As Chuck D. said, “It's not about gold or platinum, it's about one record to one person at a time.” StarPolish will help you sell your CDs online, give you more of the profits than any other online store (80%), and reward artists who sell the most CDs with cash, from $2,500 to $15,000. To make things fair, we have a level playing field, so you only need to compete with artists who sell similar amounts of CDs as you do.

Mailing Lists <LINK>

A large mailing list <LINK TO LISTS CONTENT> is both an important promotional tool as well as an impressive industry asset. StarPolish will help you build your mailing list online, and reward artists who compile the largest mailing lists with cash from $2,500 to $15,000. To make things fair, we have a level playing field, so you only need to compete with artists who have mailing lists of a similar size as yours.

Appendix B

Record Sales Rewards

Selling CDs is important for emerging artists not only as a source of income and exposure of your music to more people, but also as an industry benchmark/career highlight. Club owners, press reviewers, radio station programmers, industry talent scouts, etc. are all impressed by artists who have a strong sales history.

Because record sales can be so important in developing a career in music, StarPolish will help you sell your CDs online, and reward artists who sell the most CDs with cash from $2,500 to $15,000. Additionally, all winners will have their songs featured on a CD that will go to our 25-member A&R Panel <LINK TO SEGMENT> of music industry executives from the major and independent record labels, all actively seeking new artists to sign. No strings attached. Just honest support.

StarPolish also offers the most competitive rates on the Internet. You will get to keep 80% of all your sales. Compare us to other sites and you'see most online retailers give artists 45-65%. In addition, at StarPolish there are no sign-up fees or other hidden costs. We designed our sales system to be simple, with emerging artists'needs and best interests in mind.

To make things fair, we run two competitions or “tiers”, so you only need to compete with artists who sell as many CDs as you do. You may choose which tier you'd like to participate in, but you can only compete within one tier at any given moment. Tier 1 will award $15,000 to the artist who has sold the most CDs via StarPolish when the contest closes on MONDAY Jan. 15, 2001. Artists that sell more than 20 CDs per month are encouraged to participate in this Tier 1 competition. Tier 2 will award $2,500 to the artist who has sold the most CDs via StarPolish when the contest closes on MONDAY Jan. 15, 2001. Artists that sell less than 20 CDs per month are encouraged to participate in this Tier 2 competition.

Both Tier 1 and Tier 2 competitions will begin on MONDAY, Oct. 1, 2000, when StarPolish begins selling CDs from its Artist Community. You may join the Record Sales Competitions at any time before these competitions close, but you are encouraged to enroll immediately: Part of the enrollment process will involve you sending StarPolish your CDs to sell and there will be a time difference between when you enroll online and when we can actually start selling your CDs (as we wait for those CDs to arrive at our warehouse). Enrolling today guarantees that your CDs will be for sale via StarPolish as soon as possible.

Here's How It Works

It's simple. When you join our Artist Community <LINK>, you will be given the option to enroll in the Record Sales Competition and pick your Tier. At that moment, you will also be given specific instructions on how and where to send us your CDs for sale. If you are already a member of our Artist Community but are not enrolled in the competition, you may signup and pick your Tier at your Account Page <LINK>. Please note that once you have picked a Tier, you may not change your Tier during the competition. At your Account Page <LINK>, you will also be able check the status of your total record sales.

Once you are enrolled in the competition and your CDs arrive in our warehouse, a simple “Buy CD” feature will be added your Artist Profile within the Community. Then anyone browsing the StarPolish Artist Community <LINK> can easily purchase your music while checking out your profile.

Shortly following the close of each month, StarPolish will send you a check for your CD sales if your account balance totals $20 or more. Of course, if you ever close your account, we'll send you a check covering your account balance, no matter its size.

How To Win This Contest

Remember: The harder you work, the better your luck gets. We will make it easy for music fans to find your profile and purchase your music, but you must also work hard to promote your act and encourage potential fans to buy your CDs through StarPolish.

Study all the StarPolish advice sections, paying particular attention to the sections under“Maximum Exposure” (see the Advice Table Of Contents <LINK TO ADVICE SEGMENT>). Wherever and whenever you promote your act, promote the fact that you have a CD for sale.

Let all your friends, family, and fans know that you are participating in this StarPolish contest and how easy it is for them buy your CDs via the site. Let them also know that their support could directly lead to cash and industry exposure for you.

We don't require you to make StarPolish your exclusive online retailer, but only sales that come from the StarPolish site count towards the Record Sales Competitions—those are real sales that we can verify because they came through our site (no fudging of numbers). Therefore, if you are serious about winning this contest, you may want to make StarPolish your official—and only—online retail source, forwarding any potential online customers to your StarPolish Artist Profile. Taking things one step further, you may want to encourage potential offline customers to purchase your CDs at StarPolish to greater support your standing in the competition. This can include passing out flyers at your shows and events that highlight the contest and StarPolish.com as the best source for CD purchase.

However, selling CDs offline—at shows in particular—can be lucrative because you get to keep a good percentage of the profits, and the money is money in your hand; no waiting for a check in the mail. Therefore, we don't recommend that you discourage offline CD sales in favor of sales via StarPolish unless you feel you are close to winning the Records Sales Contest and you therefore need every online purchase to closer guarantee your cash winnings. You can find your ranking in the contest by searching for“Hot Artists” in our Artist Community <LINK> and locating your act.

Records Sales Competition Specific Rules

The following rules apply to the StarPolish CD SALES competition:

1. StarPolish will periodically award prizes to artists that sell the most CDs through the StarPolish site. The competition will contain two tiers with prizes that vary according to tier. Artists may choose which tier they would like to participate in, subject to the additional rules below. Artists may choose to compete within one and only one tier at any given moment. Once you have picked a Tier, you may not change your Tier during the competition.

2. The awards will be given to the artist whose album sells in the greatest quantity during the competition. An artist that sells multiple albums through StarPolish may enter each album in the competition, but sales of multiple albums will not be lumped together.

3. Any artist that wins a Tier 2 record sales prize will not be eligible to compete in Tier 2 of future record sales competitions unless otherwise specified, but can compete in Tier 1 of future record sales competitions.

4. StarPolish employees are not eligible for the record sales competitions. StarPolish Artist Advisory Board members are eligible for the record sales competitions, since the winners are chosen on objective, quantifiable bases.

5. Since the prizes are intended for emerging artists, artists that have sold more than 100,000 copies of any one album in any medium, or more that 500,000 copies of any combination of albums in any medium are not eligible to win any record sales-based prize.

6. Winners are responsible for paying any applicable local, state federal or other taxes. In the event of a tie, the prize will be split evenly between winners. StarPolish will comply with all applicable laws. Void where prohibited.

7. StarPolish shall retain the authority to amend these rules at its sole discretion at any time, for any purpose whatsoever, and without notice.

8. IN NO EVENT SHALL STARPOLISH, ITS SHAREHOLDERS, OFFICERS, DIRECTORS, EMPLOYEES, OR AGENTS BE LIABLE FOR ANY DIRECT, INDIRECT, PUNITIVE, INCIDENTAL, SPECIAL, CONSEQUENTIAL OR OTHER DAMAGES ARISING OUT OF OR IN ANY WAY CONNECTED TO ANY USE OF THE SITE OR: (I) RELIANCE UPON THE FUNCTIONALITY OF THE SITE, INCLUDING BUT NOT LIMITED TO SELLING YOUR CDS; (HI) DELAY EXPERIENCED BY ANY INDIVIDUAL OR ENTITY IN USING THE SITE, INCLUDING BUT NOT LIMITED TO THOSE ATTEMPTING TO PURCHASE YOUR CDs; OR (III) INABILITY OF ANY INDIVIDUAL OR ENTITY TO USE THE SITE, INCLUDING BUT NOT LIMITED TO THOSE ATTEMPTING TO PURCHASE YOUR CDs, EVEN IF STARPOLISH WAS PREVIOUSLY ADVISED OF THE POSSIBILITY OF SUCH DAMAGES. IN THE EVENT THAT ANY OF THESE LIMITATIONS OF LIABILIITY IS FORBIDDEN BY LAW, THESE DISCLAIMERS OF LIABILITY SHALL REMAIN IN FORCE TO THE EXTENT PERMITTED BY APPLICABLE LAW.

9. For promotional purposes, StarPolish shall be permitted to use the name, address, likeness and prize information of the winner of any of StarPolish's games, competitions or grants without limitation or further permission or compensation.

If you have any questions about these rules, please contact us at rewards@StarPolish.com <MAILTO LINK>.

StarPolish Sales Policy

We're confident that you won't find more favorable terms anywhere on the web, and hope that you're excited about your chance to win some serious cash and industry exposure. Please read the terms and conditions below before agreeing to sell your CDs through StarPolish. We do not require exclusivity, but as the one responsible-at least, in part-for your act's business affairs, you should always read the fine print before agreeing to any contract.

1. You authorize StarPolish LLC, its subsidiaries and affiliates (collectively, StarPolish) to sell your CD on your behalf. You will receive 80% of the list price for each CD sale. StarPolish's commission for CD sales is 20%. In addition to the list price, your fans will be charged a fee to cover the costs of shipping and handling. You won't get any of that, but we've worked out a deal with our shipping partners to keep those costs down for your fans. You may sell your CD for $10 U.S. or any price over $10 U.S.

2. StarPolish shall not sell your music except as described in this agreement without your consent.

3. Shortly following the close of each month, StarPolish will send you a check for your CD sales if your account balance totals $20 or more. Of course, if you ever close your account, we'll send you a check covering your account balance, no matter its size.

4. Your represent and warrant that you have the right and authority to enter into this agreement. You further represent that you have ownership of all copyrighted material associated with your CD, including but not limited to your master recordings and your songs. You represent that entering into this agreement will not violate any third party's intellectual property or other rights, or violate any law or regulation. You are solely responsible for any liability associated with content that you make available to StarPolish.

5. You agree that StarPolish or its users may from time to time comment on or critique your music or your act. You consent to such actions.

6. You represent and warrant that any and all information that you provide to StarPolish has been and will be truthful and accurate. You promise to promptly notify StarPolish in the event that any information that you have provided changes.

7. StarPolish may from time to time award prizes to artists that sell the most CDs on our site. StarPolish reserves the right to amend the Rules <JUMP LINK ABOVE TO SPECIFIC RULES> governing such competitions.

8. StarPolish shall have no responsibility or liability for any injury or damages arising from any breach of your representations and warranties hereunder; and shall not be liable for any lost profits, punitive, incidental or consequential damages or any claim against You by any other party. Similarly, You agree to indemnify StarPolish for any claim brought against StarPolish if such claim results from a breach of your representations and warranties hereunder.

9. In the event that StarPolish, in good faith, discovers that You have made any misrepresentations, or that continuing a relationship with you may cause StarPolish to incur any financial or criminal liability, StarPolish may terminate this agreement. If StarPolish terminates this agreement pursuant to this paragraph and is holding an inventory of your CDs, StarPolish will return your CDs to you at your expense if you so request.

10. In the event that you do not sell a total of 5 CDs in any two-month period, StarPolish may terminate this agreement. If StarPolish terminates this agreement pursuant to this paragraph and is holding an inventory of your CD, your may have your CDs returned to you at your expense. While StarPolish will attempt to make it as easy as possible for music fans to find and buy your music, it is your responsibility to promote your own CDs to drive sales. You are encouraged to read our Advice <LINK TO ADVICE SEGMENT> for promotional help.

11. Each party may terminate this contract at any time. In the event that StarPolish terminates this agreement other than as set forth above, StarPolish shall return your CDs to you at StarPolish's expense at your request. In the event that You wish to terminate this agreement and have your CDs returned to you, StarPolish will return your CDs at your expense upon request.

12. You authorize StarPolish to release information concerning you and your CD sales to SoundScan, the StarPolish A&R Panel, and other members of the entertainment community.

13. IN NO EVENT SHALL STARPOLISH, ITS SHAREHOLDERS, OFFICERS, DIRECTORS, EMPLOYEES, OR AGENTS BE LIABLE FOR ANY DIRECT, INDIRECT, PUNITIVE, INCIDENTAL, SPECIAL, CONSEQUENTIAL OR OTHER DAMAGES ARISING OUT OF OR IN ANY WAY CONNECTED TO ANY USE OF THE SITE OR: (I) RELIANCE UPON THE FUNCTIONALITY OF THE SITE, INCLUDING BUT NOT LIMITED TO SELLING YOUR CDS; (II) DELAY EXPERIENCED BY ANY INDIVIDUAL OR ENTITY IN USING THE SITE, INCLUDING BUT NOT LIMITED TO THOSE ATTEMPTING TO PURCHASE YOUR CDs; OR (III) INABILITY OF ANY INDIVIDUAL OR ENTITY TO USE THE SITE, INCLUDING BUT NOT LIMITED TO THOSE ATTEMPTING TO PURCHASE YOUR CDs, EVEN IF STARPOLISH WAS PREVIOUSLY ADVISED OF THE POSSIBILITY OF SUCH DAMAGES. IN THE EVENT THAT ANY OF THESE LIMITATIONS OF LIABILIITY IS FORBIDDEN BY LAW, THESE DISCLAIMERS OF LIABILITY SHALL REMAIN IN FORCE TO THE EXTENT PERMITTED BY APPLICABLE LAW.

Appendix C

Mailing List Rewards

A large mailing list is both an important promotional tool as well as an impressive industry asset. In fact, building your mailing list is one of the first pieces of business you should attend to. First, review our Advice Section on Mailing Lists <LINK TO LISTS CONTENT> to learn the basics of compiling, maintaining, and using your mailing list.

Because a strong mailing list is so critical for an emerging artist, StarPolish will help you build your mailing list online, and reward artists who compile the largest mailing lists with cash from $2,500 to $15,000. Additionally, all winners will have their songs featured on a CD that will go to our 25-member A&R Panel <LINK TO SEGMENT> of music industry executives from the major and independent record labels, all actively seeking new artists to sign. No strings attached. Just honest support.

As an added incentive for music fans to sign your list and support StarPolish artists, we will give away $1,000 in a random drawing to one person who supports at least one StarPolish artist by signing their mailing list. This prize will be given out after the mailing list competitions close.

To make things fair, we run two competitions or “tiers”, so you only need to compete with artists who have mailing lists of a similar size as yours. You may choose which tier you'd like to participate in, but you can only compete within one tier at any given moment.

Tier I will award $15,000 to the artist who has the most e-mail addresses on their mailing list by 5PM Eastern Standard Time MONDAY, Dec. 11, 2000, when the contest closes. Artists that typically sign-up more than 25 new fans to their mailing list per month are encouraged to participate in this Tier 1 competition. This contest has begun, and artists are welcome to join at any time.

Tier 2 will award $2,500 to the artist who has the most e-mail addresses on their mailing list by 5PM Eastern Standard Time MONDAY, Dec. 11, 2000 when the contest closes. Artists that typically sign-up less than 25 new fans to their mailing list per month are encouraged to participate in the Tier 2 competition. This contest has begun, and artists are welcome to join at any time.

Here's How It Works

It's simple. When you join our Artist Community <LINK>, you will be given the option to enroll in the Mailing List Competition and pick your Tier. If you are already a member of our Artist Community but are not enrolled in the competition, you may signup and pick your Tier at your Account Page <LINK>. Please note that once you

have picked a Tier, you may not change your Tier during the competition. At your Account Page <LINK>, you will also be able check the status of the size of the list you've compiled via StarPolish, and view or download newly added names and addresses.

Once you are enrolled, a simple mailing list signup feature will be added to your Artist Profile within the Community. Then anyone browsing the StarPolish Artist Community <LINK> can easily sign your list while checking out your profile.

Since this competition is designed to assist artists in building online mailing lists, a valid email address is required from each person who signs up; street addresses are optional.

If the person signing up is already a member of the StarPolish Community (and therefore their information is on record with us) they will not need to enter their addresses or go through a validation process; merely clicking submit on the signup tool will sign them up to your list. It's that easy.

If the person signing up is not a member of the StarPolish Community, they will need to enter their email address (and street address if they like) and a validation email will be sent to them at that address. Once they perform the simple verification step—clicking on a link within the validation email—their name will be added to your list. Also very easy.

While StarPolish will verify the names and email addresses of the people who sign your mailing list, we will not contact them again unless they specifically express a desire to become a member of the StarPolish Community.

Members of the StarPolish Community who sign any of our artists'mailing lists are automatically entered in the random drawing to win $1000 for supporting our artists by joining their mailing lists. Non-members will be given the option of entering the drawing upon email address validation.

How To Win This Contest

Remember: The harder you work, the better your luck gets. We will make it easy for music fans to find your profile and sign your mailing list, but you must also work hard to promote your act and encourage potential fans to sign your list through StarPolish. First, review the StarPolish sections on Mailing Lists <LINK TO LISTS CONTENT> and Cybermarketing And Promotion <LINK TO INTERNET/CYBERMARKETING AND PROMOTION> for extensive advice on driving people to sign your mailing lists. Second, let all your friends, family, and fans know that you are participating in this StarPolish contest and how easy it is for them to signup and support your act. Let them know that their support could directly lead to cash and industry exposure for you. Finally, let them know that by signing your mailing list, they will have the chance to win $1000 in a random drawing, rewarding one music fan who supports at least one StarPolish artist by signing their mailing list. This prize will be given out after the mailing list competitions close.

Note that as long as the email addresses being added to your list are valid and unique, anyone can submit them. What we mean is that you can-and should-collect as many email addresses offline (e.g. with a clipboard and signup sheet at your shows) as possible. Then all you need to do is go to your own StarPolish Artist Profile and add all those addresses yourself. As long as the person whose address you've entered verifies that they indeed wanted to sign your list (i.e. they reply to our validation email), those addresses will count in the competition.

Mailing List Competition: Specific Rules

The following rules apply to the StarPolish MAILING LIST competition:

1. StarPolish will periodically award prizes to artists based on the total number of members signed onto to their mailing list through the StarPolish site. The competition will contain two tiers with prizes that vary according to tier. Artists may choose which tier they would like to participate in, subject to the additional rules below. Artists may choose to compete within one and only one tier at any given moment. Once you have picked a Tier, you may not change your Tier during the competition.

2. The mailing list awards will be given to the artists that have the most verified fans on their mailing list. Only names that are accompanied by an email address will count toward the competition. StarPolish will contact via email each fan wishing to be on an artist's mailing list to verify that his or her email address is valid, and verify that he or she indeed wishes to be on that artist's mailing list. StarPolish reserves the right, without notice, to change this method of verification or perform additional verification procedures.

3. While StarPolish will verify the names and email addresses of the people who sign our artists'mailing lists, we will not contact them again unless they specifically express a desire to become a member of the StarPolish Community.

4. Any artist that wins a Tier 2 mailing list prize will not be eligible to compete in Tier 2 of future mailing list competitions unless otherwise specified, but can compete in Tier 1 of future mailing list competitions. Any artist that wins a Tier 1 mailing list prize will no longer be eligible to compete in future mailing list competitions unless otherwise specified.

5. StarPolish employees are not eligible for the mailing list competitions. StarPolish Artist Advisory Board members are eligible for the mailing list competitions, since the winners are chosen on objective, quantifiable bases.

6. While fans are encouraged to join as many mailing lists as they desire, each fan may only be entered once to win the $1000 prize, chosen at random.

7. Since the prizes are intended for emerging artists, artists that have sold more than 100,000 copies of any one album in any medium, or more that 500,000 copies of any combination of albums in any medium are not eligible to win any mailing list-based prize. 8. Winners are responsible for paying any applicable local, state, federal or other taxes. In the event of a tie, the prize will be split evenly between winners. StarPolish will comply with all applicable laws. Void where prohibited. 9. StarPolish shall retain the authority to amend these rules at its sole discretion at any time, for any purpose whatsoever, and without notice.

10. IN NO EVENT SHALL STARPOLISH, ITS SHAREHOLDERS, OFFICERS, DIRECTORS, EMPLOYEES, OR AGENTS BE LIABLE FOR ANY DIRECT, INDIRECT, PUNITIVE, INCIDENTAL, SPECIAL, CONSEQUENTIAL OR OTHER DAMAGES ARISING OUT OF OR IN ANY WAY CONNECTED TO ANY USE OF THE SITE OR: (I) RELIANCE UPON INFORMATION PROVIDED BY THE SITE INCLUDING BUT NOT LIMITED TO FAN INFORMATION COLLECTED ON BEHALF OF ARTISTS; (II) DELAY EXPERIENCED BY ANY INDIVIDUAL OR ENTITY IN USING THE SITE, INCLUDING BUT NOT LIMITED TO FANS TRYING TO JOIN AN ARTIST'S MAILING LIST; OR (III) INABILITY OF ANY INDIVIDUAL OR ENTITY TO USE THE SITE, INCLUDING BUT NOT LIMITED TO FANS TRYING TO JOIN AN ARTIST'S MAILING LIST, EVEN IF STARPOLISH WAS PREVIOUSLY ADVISED OF THE POSSIBILITY OF SUCH DAMAGES. IN THE EVENT THAT ANY OF THESE LIMITATIONS OF LIABILITY IS FORBIDDEN BY LAW, THESE DISCLAIMERS OF LIABILITY SHALL REMAIN IN FORCE TO THE EXTENT PERMITTED BY APPLICABLE LAW.

11. For promotional purposes, StarPolish shall be permitted to use the name, address, likeness and prize information of the winner of any of StarPolish's games, competitions or grants without limitation or further permission or compensation.

If you have any questions about these rules, please contact us at rewards@starpolish.com <mailto link>. resulted in the most sales, generated the most revenue, or caused an increase in revenue or products sold for the merchant as a result of such references wins a prize from the merchant:

What is claimed is:

1. A computer-implemented system comprising a merchant Web site that is operated by a merchant, said site being configured to sell products of suppliers, said merchant providing criteria by which said suppliers can compete for an award; and said merchant awarding a prize to the supplier that most successfully accomplishes said criteria in a given time period.

2. The system described in claim 1, wherein said site includes registration software, a product database, as Web server, an inventory tracking system, and an e-commerce system.

3. The system described in claim 2, wherein said criteria are selected from one or more of the following: greatest number of units sold of a particular product, most customers referred from supplier's Web-site; most sales revenue from a particular product, most new mailing list entries, greatest profit from a particular product, greatest increase in number of sales of a particular product, greatest increase in sales revenue from a particular product, greatest number of units sold of all of said supplier's products, most sales revenue from sales of all of said supplier's products, greatest profit from sales of all of said supplier's products, greatest increase in number of sales of all of said supplier's products, and greatest increase in sales revenue from all of said supplier's products.

4. The system described in claim 3 wherein said suppliers compete for a second place award and a third-place award.

5. The system described in claim 4, wherein said suppliers are categorized into tiers, whereby an award is provided to the supplier that most successfully accomplishes said criteria in each tier.

6. The system described in claim 5, wherein said tiers have restrictions for participation.

7. The system described in claim 6, wherein said restrictions are selected from the following: cumulative sales in number of units of a particular product, sales in number of units of a particular product within a given time frame, sales in number of units of said supplier's cumulative line of products within a given time frame, cumulative sales in number of units of said supplier's cumulative line of products within a given time frame, cumulative sales in dollars of a particular product, sales in dollars of a particular product within a given time frame, sales in dollars of said supplier's cumulative line of products within a given time frame, or cumulative sales in dollars of said supplier's cumulative line of products within a given time frame.

8. A method of selling items by a merchant comprising: providing a computer-based system that offers products of suppliers for sale to consumers; providing criteria by which said suppliers can compete for an award; and providing said award to the supplier that most successfully accomplishes said criteria in a given time period.

9. The method described in claim 8, wherein said computer-based system includes a Website configured to conduct said sale.

10. The method described in claim 8, wherein said computer-based system includes a wireless device for purchasing said products.

11. The methods described in claim 9, wherein said criteria are selected from one or more of the following: greatest number of units sold of a particular product, most customers referred from supplier's Web-site; most sales revenue from a particular product, most new mailing list entries, greatest profit from a particular product, greatest increase in number of sales of a particular product, greatest increase in sales revenue from a particular product, greatest number of units sold of all of said supplier's products, most sales revenue from sales of all of said supplier's products, greatest profit from sales of all of said supplier's products, greatest increase in number of sales of all of said supplier's products, and greatest increase in sales revenue from all of said supplier's products.

12. The methods described in claim 10, wherein said criteria are selected from one or more of the following: greatest number of units sold of a particular product, most customers referred from supplier's Web-site; most sales revenue from a particular product, most new mailing list entries, greatest profit from a particular product, greatest increase in number of sales of a particular product, greatest increase in sales revenue from a particular product, greatest number of units sold of all of said supplier's products, most sales revenue from sales of all of said supplier's products, greatest profit from sales of all of said supplier's products, greatest increase in number of sales of all of said supplier's products, and greatest increase in sales revenue from all of said supplier's products.

13. The method of claim 11, wherein said suppliers compete for a second place award and a third-place award.

14. The method of claim 11, wherein said suppliers are categorized into tiers, whereby an award is provided to the supplier that most successfully accomplishes said criteria in each tier.

15. The method of claim 14, wherein said tiers have restrictions for participation.

16. The method of claim 15, wherein said restrictions are selected from the following: cumulative sales in number of units of a particular product, sales in number of units of a particular product within a given time frame, sales in number of units of said supplier's cumulative line of products within a given time frame, cumulative sales in number of units of said supplier's cumulative line of products within a given time frame, cumulative sales in dollars of a particular product, sales in dollars of a particular product within a given time frame, sales in dollars of said supplier's cumulative line of products within a given time frame, or cumulative sales in dollars of said supplier's cumulative line of products within a given time frame.

17. A method of selling items by a merchant comprising:
providing a site on the World Wide Web that offers one or more said items for sale from each of a plurality of suppliers, said site providing sales services allowing consumers to electronically purchase said items;
providing a computer program to track said purchases; said computer program configured to determine which of said suppliers'products have sold in the greatest quantity; and
providing a prize to said supplier whose products have sold in the greatest quantity.

18. A method of selling items by a merchant comprising:
providing a site on the World Wide Web that offers one or more items for sale from each of a plurality of suppliers, said site providing sales services allowing consumers to electronically purchase said items;
providing a computer program to track said purchases; said computer program configured to determine which of said suppliers'sales have generated the most revenue; and
providing a prize to said supplier whose product's sales have generated the most revenue.

19. A method of selling items by a merchant comprising:
providing a merchant site on the World Wide Web that offers one or more said items for sale from each of a plurality of suppliers, said site providing sales services allowing consumers to electronically purchase said items;
associating with middle-men that each provide a referral site on the World Wide Web that contains a hyperlink to said merchant site;
said merchant site providing a computer program to track said purchases;
said computer program configured to determine which of said suppliers'products have sold in the greatest quantity as a result of consumers visiting said merchant site through said hyperlinks; and
providing a prize to said supplier whose products have sold in the greatest quantity as a result of consumers visiting said merchant site through said hyperlinks.
